(19) United States
(12) Patent Application Publication
(10) Pub. No.: US 2008/0119950 A1
(43) Pub. Date: May 22, 2008

(54) FUEL SUPPLY SYSTEM AND OPERATING METHOD THEREFORE

(76) Inventor: CHUN-CHIN TUNG, CHUPEI (TW)

Correspondence Address: G. LINK CO., 3550 BELL ROAD, MINOOKA, IL, 60447, US

(21) Appl. No.: 11/941,929

(22) Filed: Nov. 17, 2007

(30) Foreign Application Priority Data
Nov. 20, 2006 (TW) 095142869

(51) Int. Cl. G05B 13/02

(52) U.S. Cl. 700/52

(57) ABSTRACT

The present invention relates to a fuel supply system and operating method therefor, comprising: a fuel cartridge; a fuel level detection element; a main control unit; and an electronic apparatus, wherein the fuel level detection element utilizes the capacitance effect to detect the residual amount of fuel in the fuel cartridge and transmits the detected signal of residual fuel amount to the main control unit, where the computing device in the main control unit coupled with the means of converting fuel volume into remaining running time of electronic apparatus in the memory element calculate the remaining running time of the electronic apparatus, and the electronic apparatus provides information on the residual fuel amount in the fuel cartridge and its remaining running time for the reference of the user.

### FIELD OF THE INVENTION

The present invention relates to a fuel supply system and operating method therefore, particularly an algorithm and related physical quantity sensing and computing device to convert the residual fuel amount in the fuel container into the duration of remaining usable power.

### BACKGROUND OF THE INVENTION

Conventional fuel cell as proposed by Willard T. Grubb in 1957 is a proton exchange membrane system (PEMFC) that uses hydrogen as fuel. But hydrogen poses considerable hazard if it is stored in high-pressure cylinder or poses a weight problem if it is stored in the form of hydrogen alloy. In light of the drawbacks presented by PFMFC, direct methanol fuel cell (DMFC) that uses relatively convenient and safer methanol as fuel has been proposed. There are a variety of approaches to measuring the residual fuel volume in the fuel container of a DMFC, for example, by capacitance, buoy (float), pressure, photosensitivity, and sonic wave. However those approaches do not provide information on the residual amount of methanol in the fuel container or the remaining usable time of the electronic apparatus powered by the fuel cell system, and they do not meet the demands of micro electronic apparatus.

In view of the problems just discussed, the present invention aims to provide an algorithm and related device that can convert the residual fuel amount in the fuel container into the remaining running time of an electronic apparatus and inform the user of the electronic apparatus, which effectively addresses the drawbacks of the prior art.

### SUMMARY OF THE INVENTION

The primary object of the invention is to provide a fuel supply system and its operating method where the residual fuel amount in the fuel container can be computed by a fuel sensing unit to let the user know the remaining running time of the electronic apparatus as powered by the residual fuel.

Another object of the invention is to detect the power consumption of an electronic apparatus and relay the signal to a control element for recordation to facilitate the calculation of remaining running time of the electronic apparatus based on the residual fuel amount in the fuel container.

Yet another object of the invention is to record the usage habit of the electronic apparatus user and provide such information to a control unit to calculate the duration of power that can be supplied to the electronic apparatus by the residual fuel in the fuel container.

A further object of the invention is to monitor real-time massive power output and relay instantly the signal to a control unit for it to recalculate the remaining running time of an electronic apparatus based on the residual fuel amount.

An other object of the invention is to monitor the fuel transport pump of a fuel container, record the relationship between its working time and the running time of an electronic apparatus and relay the recorded values to a control unit so as to provide reference to the residual fuel amount in the fuel container and the remaining running time of the electronic apparatus.

To achieve the aforesaid objects, the invention mainly provides a fuel supply system and operating method therefor, comprising: a fuel cartridge; a fuel level detection element; a main control unit; and an electronic apparatus wherein the fuel level detection element utilizes the capacitance effect to detect the residual amount of fuel in the fuel cartridge and transmits the detected signal of residual fuel amount to the main control unit, where the computing device in the main control unit coupled with the means of converting fuel volume into remaining running time of electronic apparatus in the memory element calculate the remaining running time of the electronic apparatus, and the electronic apparatus provides information on the residual fuel amount in the fuel cartridge and its remaining running time for the reference of the user.

The control unit has the mechanism to record the usage habit of the electronic apparatus user and reflect instantly massive power consumption of the electronic apparatus so as to recalculate the remaining running time of the electronic apparatus as powered by the residual fuel in the fuel container.

Aside from the fuel level detection element, the control unit can also use the working of fuel supply pump as basis for calculating the fuel consumption of the electronic apparatus and providing reference for the remaining duration of fuel supply.

The objects, features and method of the invention as well as implementation of the invention are described in detail below with embodiments in reference to the accompanying drawings.

### BRIEF DESCRIPTION OF THE DRAWINGS

FIG. 1 is a schematic diagram showing the relations of the components in the fuel supply system according to the invention;

FIG. 2 is a flow chart showing the operating steps of the fuel supply system according to the invention;

FIG. 3 is a schematic diagram showing the fuel container monitoring device in the fuel supply system according to the invention;

FIG. 4 is a diagram showing another embodiment of the fuel supply system according to the invention;

FIG. 5 is a diagram showing yet another embodiment of the fuel supply system according to the invention;

FIG. 6 is a diagram showing the working of pump in the fuel supply system in FIG. 5 relative to time;

FIG. 7 shows yet another embodiment of the fuel supply system according to the invention; and

FIG. 8 is a diagram showing working of pump in the fuel supply system in FIG. 7 relative to time.

### DETAILED DESCRIPTION OF THE INVENTION

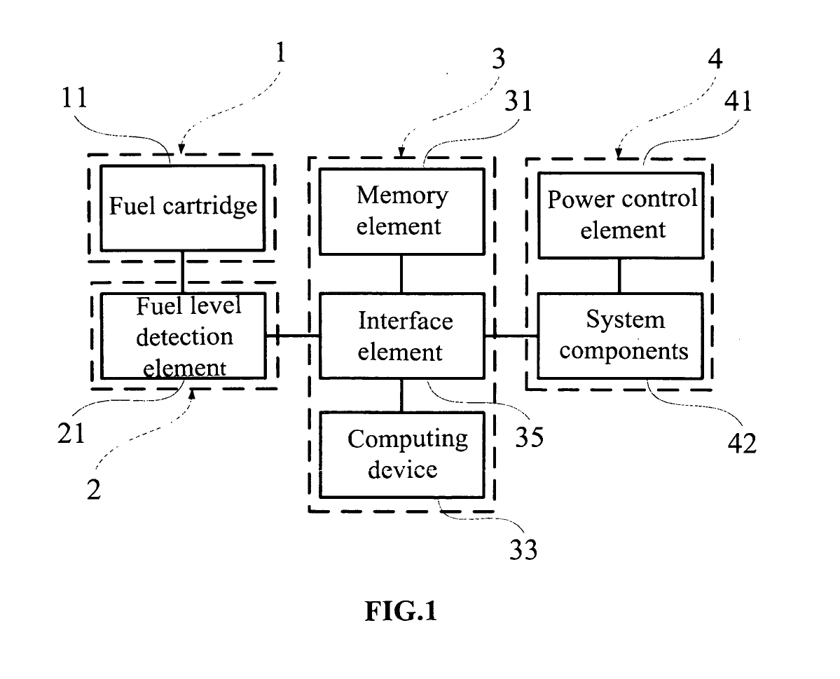

FIG. 1 is a schematic diagram showing the relations of the components in the fuel supply system according to the invention. As shown, the fuel supply system comprises a fuel supply unit (1), a fuel sensing unit (2), and a main control unit (3). The fuel supply unit (1) consists of a fuel cartridge (11) that contains a fuel storage space and a fuel transport structure for storing and supplying the fuel needed for the operation of a fuel cell. Moreover, the fuel sensing unit (2) consists of a fuel level detection element (21) for measuring the residual fuel amount in the fuel cartridge (11). The main control unit (3) consists of a memory element (31), a computing device (33) and an interface element (35), wherein the memory element (31) is a data storage device, the computing device (33) is a microcontroller, and the interface element (35) is used for the transmission of information. Thus when the fuel level detection element (21) in the fuel sensing unit (2) measure the physical quantity corresponding to the amount of fuel in the fuel cartridge (11), the physical quantity information is recorded in the memory element (31), and at the same time, transferred to the computing device (33) for computing the fuel amount and corresponding remaining running time. The computing results of the computing device (33) are stored in the memory element (31) and transmitted through the interface element (35).

The fuel supply system of the invention can be electrically connected to an external electronic apparatus (4) through the interface element (35) of the main control unit (3) to transmit the information of the main control unit (3) to such electronic apparatus (4). The electronic apparatus (4) is powered by the fuel cell (not shown in the figure), while the fuel supply system of the invention supplies the fuel needed for the operation of fuel cell that powers the electronic apparatus (4).

The main control unit (3) of the fuel supply system can be disposed in the fuel supply unit (1) or in the electronic apparatus (4). In the configuration where the main control unit (3) is disposed in the electronic apparatus (4), the main control unit (3) is integrated into the circuitry of the electronic apparatus (4), or implemented via a software or firmware program executed in the electronic device (4). Specifically, in the case where the electronic apparatus (4) is a notebook computer (not shown in the figure), the main control unit (3) is configured on the motherboard of the electronic apparatus (4) or implemented as a program in the operating system of the electronic apparatus (4).

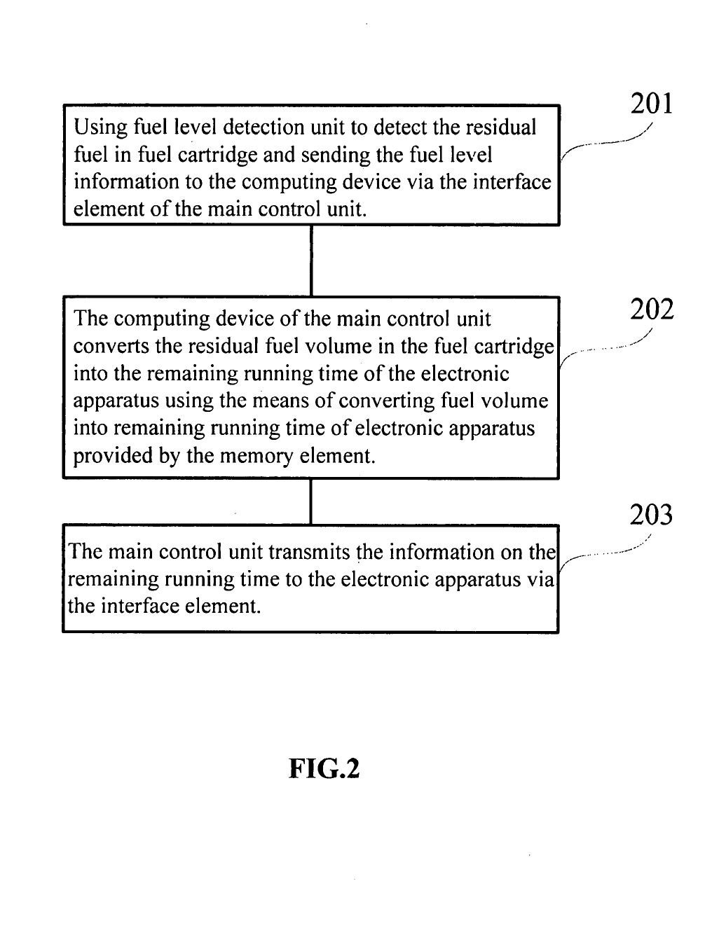

FIG. 2 is a flow chart showing the operating steps of the fuel supply system according to the invention. As shown, the implementation of the fuel supply system comprises: step 201 where the fuel level detection element (21) in the fuel sensing unit (2) detects the residual fuel amount in the fuel cartridge (11) of the fuel supply unit (1) and transfers such signal to the computing device (33) via the interface element (35) in the main control unit (3); step 202 where the computing device (33) in the main control unit (3) uses the means of converting fuel volume into remaining running time of electronic apparatus in the memory element (31) to compute the remaining running time of the electronic apparatus (4) based on the residual fuel amount; and step 203 where the information on the residual fuel amount in the fuel cartridge and the remaining running time of the electronic apparatus (4) is transmitted to the electronic apparatus (4) and displayed for user reference.

The aforesaid means of converting fuel volume into remaining running time of electronic apparatus provided by the memory element (31) comprises a power consumption model corresponding to the electronic apparatus (4), including, for example, notebook computer, mobile handset and camera, and the computing device (33) can select any power consumption mode to calculate the remaining running time of the electronic apparatus (4) based on the fuel amount in the fuel cartridge (11) using the means of converting fuel volume into remaining running time of electronic apparatus provided by the memory element (31).

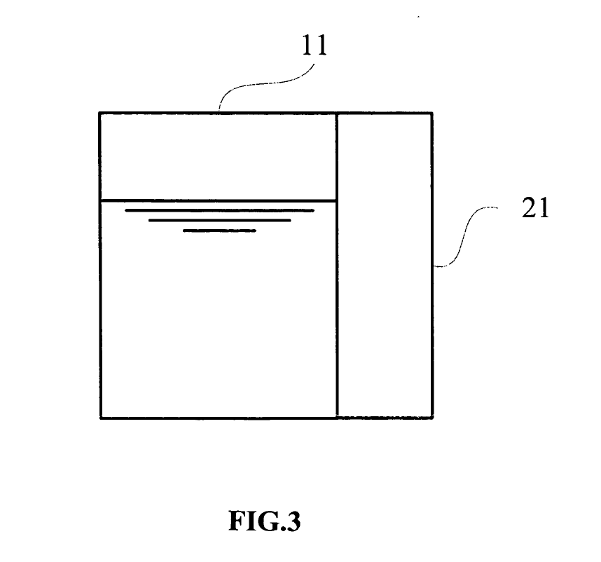

As shown in FIG. 3 which is a schematic diagram showing the fuel container monitoring device in the fuel supply system according to the invention, which defines a fuel cartridge (11), the fuel cartridge being a storage container filled with highly concentrated hydrogen-rich liquid fuel, and a fuel level detection element (21). The fuel level detection element (21) is a capacitance-based fluid metering device as disclosed in this inventor's ROC patent application No. 95104177. Said capacitance-based fluid metering device utilizes the characteristics of different capacitance due to different dielectric constant brought about by different ratio of fuel to air inside the fuel cartridge (11). The capacitance value is transmitted to the computing device (33) via the interface element (35) in the main control unit (3). The computing device (33) would use the means of corresponding the capacitance information stored in the memory element (31) to the residual fuel amount to convert the signal detected by the fuel level detection element (21) into the residual fuel amount in the fuel cartridge, and calculates the remaining running time of the electronic apparatus based on the residual fuel volume using the means of converting residual fuel volume into remaining running time of electronic apparatus provided by the memory element (31). The computing device (33) also delivers the residual fuel information to the memory element (31) for recordation to facilitate the application of the fuel cartridge (11) in other electronic apparatuses (4). When the fuel cartridge (11) is used by another electronic apparatus (4), the main control unit (3) would compute based on the record in the memory element (31) to obtain the residual fuel volume in the fuel cartridge (11) and the remaining running time of the electronic apparatus (4).

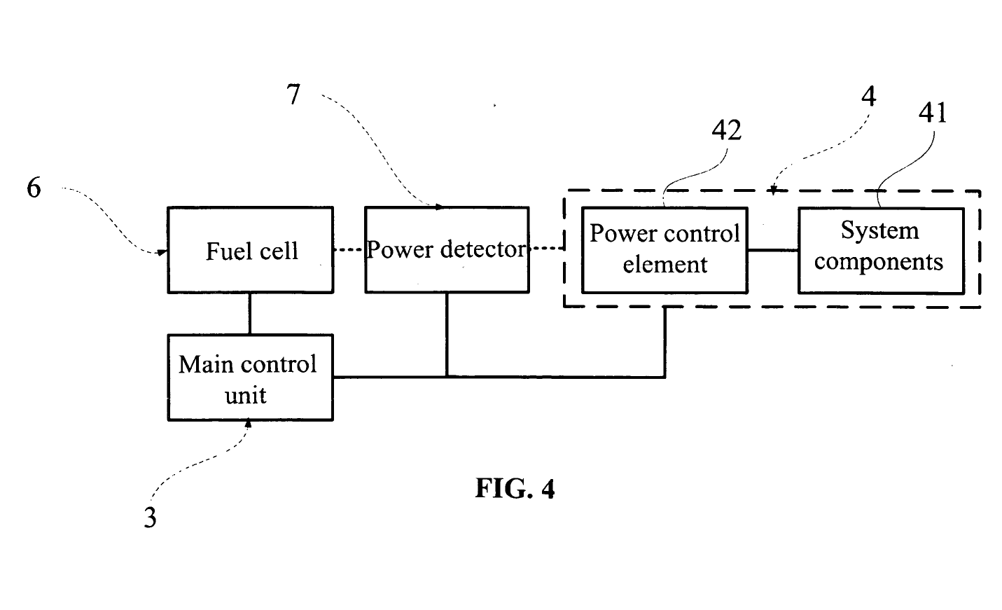

FIG. 4 is a diagram showing another embodiment of the fuel supply system according to the invention. As shown, the fuel cell supplies power to a power control unit (42) of the electronic apparatus (4), which uses power detector (7) to monitor the voltage and current inputs to the electronic apparatus (4) so as to monitor real-time the power consumption mode of the electronic apparatus (4) and transfer such information to the main control unit (3). The computing device (33) in the main control unit (3) would calculate the remaining running time of the electronic apparatus based on the residual fuel amount in the fuel cartridge of fuel cell. If the power detector (7) monitors massive power consumption based on the voltage/current output of the electronic apparatus (4), the information is instantly transmitted to the main control unit (3) where the computing device (33) therein would select another means of converting fuel volume into remaining running time of electronic apparatus (4) in the memory element (31) for re-computation to obtain the remaining running time of the electronic apparatus (4).

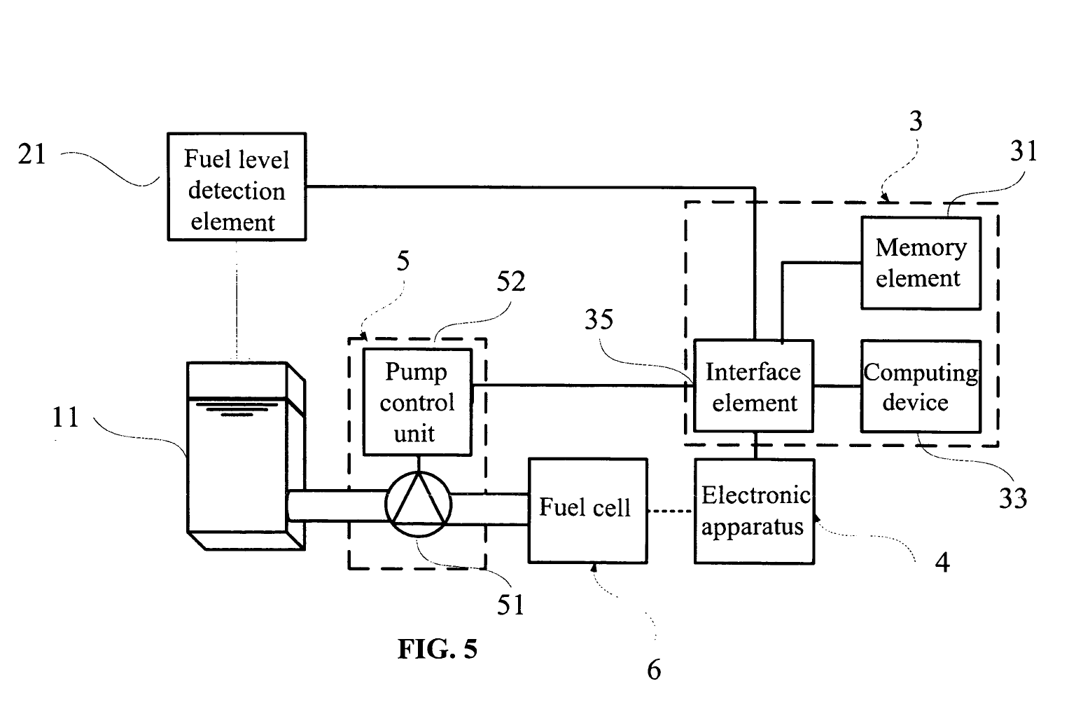

FIG. 5 is a diagram showing yet another embodiment of the fuel supply system according to the invention where the hydrogen-rich fuel in the fuel cartridge (11) is transported to the fuel cell (6) via a transport pump (51) in the fuel supply system (5), and another pump control unit (52) controls the on/off time and fuel transport behavior of the pump based on the power needs of the electronic apparatus (4). The pump control unit (52) also transfers the information on the on/off time of the pump to the computing device (33) via the interface element (35) of the main control unit (3). The computing device (33), based on the fuel transport rate (CC/sec) pre-stored in the memory element (31), calculates the running time of the electronic apparatus (4) as powered by the residual fuel for the reference of the user of electronic apparatus (4).

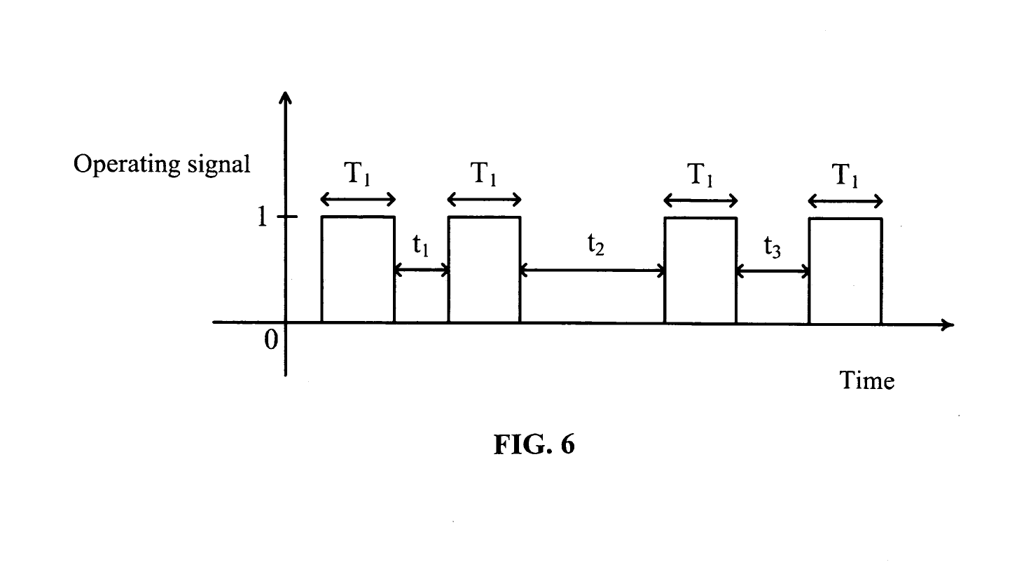

FIG. 6 is a diagram showing the working of pump in the fuel supply system in FIG. 5 relative to time, where the main control unit (3) calculates the remaining running time of the electronic apparatus (4) based on the duration of pump operation as monitored by the pump control unit (52). The x-axis depicts time, while the y-axis depicts operating signal. Signal 1 denotes pump on and signal 0 denotes pump off. T1 denotes the pump on time, and t1, t2 and t3 denotes the duration from pump off to the time of next pump on. The memory element (31) of the main control unit (3) can record t1, t2 and t3, and the computing device (33) can compute the power consumption of the electronic apparatus (4) based on the non-action duration of the pump corresponding to the usage of the electronic apparatus (4).

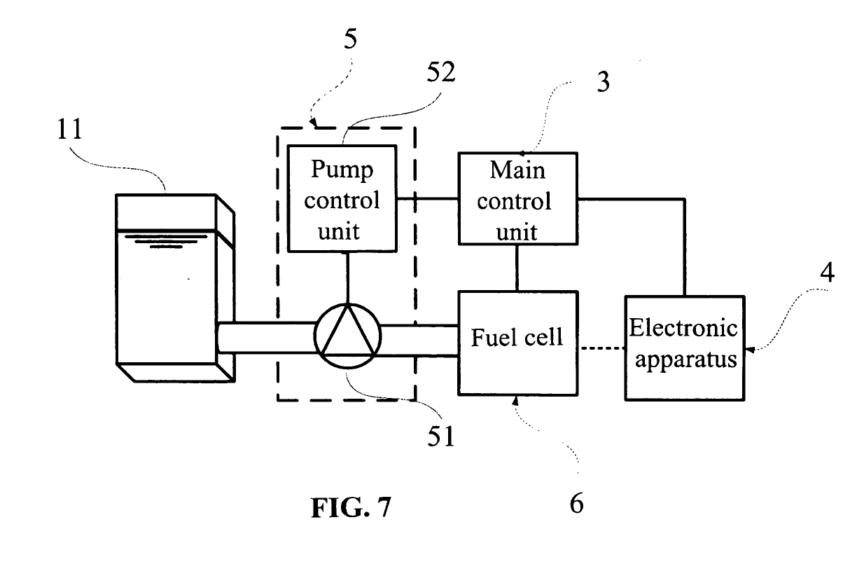

FIG. 7 shows yet another embodiment of the fuel supply system according to the invention where the hydrogen-rich fuel in the fuel cartridge (11) is transported to the fuel cell (6) via a transport pump (51) in the fuel supply device (5), and another pump control unit (52) controls the on/off time and fuel transport behavior of the pump based on the power needs of the electronic apparatus (4). The pump control unit (52) also transfers the information on the on/off time of the pump to the main control unit (3) for computation. Given that the fuel transport rate (CC/sec) is a constant value, the residual fuel amount and the remaining running time of the electronic apparatus (4) can be calculated based on the operating time and transport flow of the pump.

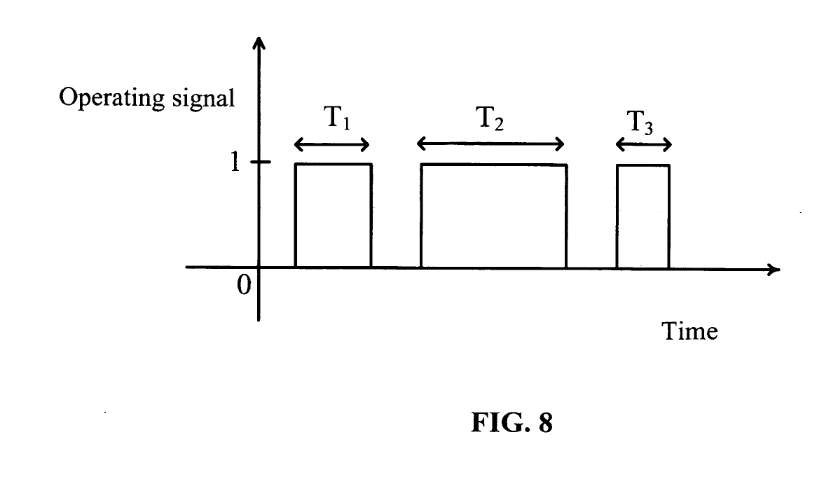

FIG. 8 is a diagram showing working of pump in the fuel supply system in FIG. 7 relative to time, where the x-axis depicts time, and y-axis depicts operating signal; signal 1 denotes pump on, signal 0 denotes pump off, and T1, T2 and T3 denote respectively the pump on time for calculating the residual fuel volume in the fuel cartridge (11). The pump control unit (52) would control the action of transport pump (51) when the fuel concentration in the fuel cell (6) becomes insufficient. Given that the pump transport flow is a constant value, the remaining running time of the electronic apparatus (4) can be calculated based on the record of fuel transport time of the transport pump (51) when it is turned on by the pump control unit (52) and the initial fuel amount in the fuel cartridge (11) recorded by the memory element (31) and read by the main control unit (3). The method presented in this embodiment can replace the capacitance-based fuel level detection method described above.

The embodiments of the present invention have been disclosed. However the disclosed embodiments should not be construed as a limitation on the actual applicable scope of the invention, and as such, all modifications and alterations without departing from the spirits of the invention and appended claims shall remain within the protected scope and claims of the invention.

What is claimed is:

1. A fuel supply system operating method for use in the mechanism of fuel cell supply to an electronic apparatus and comprising the steps of:
providing a fuel supply unit, a fuel sensing unit and a main control unit, the main control unit comprising a memory element, a computing device and an interface element, the memory element being a data storage device containing a means of converting fuel volume into remaining running time of electronic apparatus, such means comprising the relationship between fuel volume and remaining running time of the electronic apparatus; the fuel sensing unit detecting the fuel volume in the fuel supply unit and transferring the fuel volume information to the main control unit;
the computing device converting the fuel volume information into the remaining running time of the electronic apparatus using the means of converting fuel volume into remaining running time of electronic apparatus in the memory element.

2. The fuel supply system operating method according to claim 1, wherein the fuel sensing unit comprises a fuel level detection element, the fuel level detection element being a capacitance-based fluid metering element and further comprising the steps of:
the fuel level detection element in the fuel sensing unit detecting the height of fuel level in the fuel supply unit, the fuel volume being the height of the fuel level detected which is transmitted to the main control unit.

3. The fuel supply system operating method according to claim 1, wherein the relationship between the fuel volume and the remaining running time of electronic apparatus in the means of converting fuel volume into remaining running time of electronic apparatus includes the power consumption mode of the electronic apparatus.

4. The fuel supply system operating method according to claim 2, wherein the power consumption mode includes notebook computer power consumption mode, mobile handset power consumption mode, and camera power consumption mode.

5. The fuel supply system operating method according to claim 1, wherein the means of converting fuel volume into remaining running time of electronic apparatus includes the mode of user's power consumption habit.

6. The fuel supply system operating method according to claim 1, further comprising the steps of:
providing a power detector to monitor the electric power of the electronic apparatus; and
the means of converting fuel volume into remaining running time of electronic apparatus including the relationship between the electric power of the electronic apparatus and fuel consumption.

7. The fuel supply system operating method according to claim 6, wherein when the electronic apparatus shows greater power demand under real-time monitoring, a power control mode can be generated in conjunction with main control unit's re-computation of remaining running time of the electronic apparatus based on the residual fuel.

8. The fuel supply system operating method according to claim 1, wherein the main control unit is provided in the fuel supply unit.

9. The fuel supply system operating method according to claim 1, wherein the main control unit is integrated in the circuitry of the electronic apparatus.

10. The fuel supply system operating method according to claim 1, wherein the main control unit is a software or firmware program executed in the electronic apparatus.

11. A fuel supply system operating method for use in the mechanism of fuel cell supply to an electronic apparatus and comprising the steps of:
providing a fuel supply unit, a fuel supply device and a main control unit, the main control unit comprising a memory element, a computing device and an interface element, the memory element being a data storage device containing a means of converting fuel volume into remaining running time of electronic apparatus, such means comprising the relationship between fuel volume and remaining running time of the electronic apparatus; the main control unit computing the fuel volume drawn by the fuel supply device from the fuel supply unit and computing the fuel volume remaining in the fuel supply unit and transmitting such information to the main control unit;
the computing device converting the fuel volume information into the remaining running time of the electronic apparatus using the means of converting fuel volume into remaining running time of electronic apparatus in the memory element.

12. The fuel supply system operating method according to claim 11, wherein the fuel supply device consists of a transport pump and a pump control unit, and further comprising the steps of:
the computing device of the main control unit computing the fuel volume drawn by the fuel supply device from the fuel supply unit based on the control information provided by the pump control unit.

13. The fuel supply system operating method according to claim 11, wherein the relationship between fuel volume and remaining running time of the electronic apparatus in the means of converting fuel volume into remaining running time of electronic apparatus includes the power consumption mode of the electronic apparatus.

14. The fuel supply system operating method according to claim 13, wherein the power consumption mode includes notebook computer power consumption mode, mobile handset power consumption mode and camera power consumption mode.

15. The fuel supply system operating method according to claim 11, wherein the means of converting fuel volume into remaining running time of electronic apparatus includes the mode of user's power consumption habit.

16. The fuel supply system operating method according to claim 11, further comprising the steps of:
providing a power detector to monitor the electric power of the electronic apparatus; and
the means of converting fuel volume into remaining running time of electronic apparatus including the relationship between the electric power of the electronic apparatus and fuel consumption.

17. The fuel supply system operating method according to claim 16, wherein when the electronic apparatus shows greater power demand under real-time monitoring, a power control mode can be generated in conjunction with main control unit's re-computation of remaining running time of the electronic apparatus based on the residual fuel.

18. The fuel supply system operating method according to claim 11, wherein the main control unit is provided in the fuel supply unit.

19. The fuel supply system operating method according to claim 11, wherein the main control unit is integrated in the circuitry of the electronic apparatus.

20. The fuel supply system operating method according to claim 11, wherein the main control unit is a software or firmware program executed in the electronic apparatus.
